(19) United States
(12) Patent Application Publication
(10) Pub. No.: US 2012/0183276 A1
(43) Pub. Date: Jul. 19, 2012

(54) Method and Apparatus for Transmission of Data or Flags Indicative of Actual Program Recording Times or Durations

(75) Inventors: Ronald Quan, Cupertino, CA (US); Barbara F. Skliba, Mountain View, CA (US); Jenny Diane Abbott, Mountain View, CA (US)

(73) Assignee: Rovi Technologies Corporation

(21) Appl. No.: 13/009,734

(22) Filed: Jan. 19, 2011

(51) Int. Cl. H04N 5/76; H04N 9/80; H04N 5/92

(52) U.S. Cl. 386/244; 386/297; 386/245; 386/251; 386/E05.001; 386/E05.009; 386/E09.011

(57) ABSTRACT

A system for altering the recording time and or duration of a video program is provided via data sent to a recorder. The scheduled time for recording one or more programs then may be altered or overridden by the data sent to the recorder. For example, the data may be sent by a service provider or broadcaster of video programs. Alternatively, certain phrases relating to a change in a program's duration in an audio channel or closed caption channel are recognized or sensed to update or alter the recording time of the recorder. The system may include a provision to record one or more video programs with reduced commercial advertisements, or a recording with substantially commercial advertisements.

### BACKGROUND

The present invention is related to the field of recording video programs and, more particularly, to a method and apparatus for setting the time or duration of a video recording as directed by a provider or user.

Technology for providing control of the time or duration of video recording has been developed by the company, Gemstar-TV Guide International, Inc., based in Los Angeles, Calif., and includes a product, VCR+ which enters a coded number. For example, a user scans a television guide publication for a numerical code that is associated with a particular television program. The user then enters this VCR+ numerical code into a video recorder to set the recording time, channel and date.

Alternatively, the user may manually set up the channel number, time, and date of each television program.

However, because not all television programs are broadcast at the scheduled time and or time duration, the above mentioned conventional methods fail to allow for an accurate start and end time for recording television programs. For example, sports events such as baseball, tennis, and or football may not have definite broadcast durations. Thus, setting the recorder via posted schedules can lead to recording only a portion of the video program.

### SUMMARY

The present invention overcomes the shortcomings of conventional methods for controlling the time and duration of video recording. To this end, one embodiment includes data or a signal supplied by a broadcaster, or an external signal that is coupled to a recorder, to provide an accurate, or updated recording start time and or recording duration. The data or signal coupled to the recorder may override the original commands or recording time entry of the user.

The updated data or signal indicative of the actual time and interval of a video program is processed by the recorder. If the video program runs over into to the next time period, the data or signal keeps the recorder on for the extended time and or optionally plus any extra time entered by the user.

For example, the record control signal includes data of the title of the show, which is matched to the programming guide, whereby the record signal stays on, or provides a logic signal which keeps the recorder on for as long as the particular show or program is on.

Alternatively, data or metadata may be sent, coupled, or updated to the recorder so as to provide actual end time of the video program. The data or metadata is read within the recorder and is transformed into a command or control signal to set the record duration, start time, and or end time for recording one or more programs.

In time zones wherein the program has already aired, an updated programming guide is read for actual start and stop times. For example, due to the different time zones across the United States, programs on the East Coast are broadcast three hours earlier than the time on the West Coast. Accordingly, a network, system operator, television station, or the like may supply a signal, control bit, and or flag to recorders on the West Coast to provide information on the actual recording time, start time, and or end time of the program.

In another example, sometimes programs do not start or end on the hour or half hour. For instance, many PBS (Public Broadcasting System) programs do not start on the hour or half-hour, and the schedule is shown in advance. This data, which can be sent via a network such as PBS, is used to provide actual recording times to a recorder.

Another embodiment includes a signal indicative of the fact that the show or program is running over or under its allotted time period, which information is then coupled to the recorder for adjustments in recording time.

An embodiment may include a reader, which monitors or reads data from a Moving Picture Experts Group (MPEG) bit stream of the channel selected. Encoded into a portion of the MPEG or digital bit stream is command information to add/subtract time (duration) to the recorder operation. For example, if a channel is being recorded, a tuner in the recorder reads information that is embedded in the video signal to add recording time by “X” amount. So even though the recorder is set to stop recording at a particular time, the “end time” for the recording is extended.

In another embodiment, an auxiliary or second tuner may tune to one or more channels and scan or read for information pertaining to updated program schedules or program duration. The auxiliary tuner provides the updated information to the recorder for one or more channels. For example, if multiple channels and or programs are to be recorded, an auxiliary tuner gathers the updated information, which thus allows the main tuner to provide the video signal for recording in an uninterrupted manner. That is, if the auxiliary tuner is not available, then the main tuner needs to perform multiple duties, such as scanning for updated programming schedules and also providing the video signal necessary for recording.

In another embodiment, if the (e.g., selected) program that is being recorded terminates earlier than its scheduled time or duration, command information is added to the corresponding bit stream to subtract or shorten an end time for the recording.

In another embodiment, as the program is being recorded on a recorder, timecode from the program source (e.g., broadcast, cable, satellite, Internet, digital delivery network) to set the end time entered by a user on the recorder, is compared with an actual end time as provided by the system operator. A comparison is made so that if more or less recording time is needed to record the entire program, one or more bit pattern(s) is sent along with the video signal. The bit pattern then is read and used to determine whether the presently recorded program needs to be terminated earlier than set, or extended later than set.

In another embodiment, the tuner/recorder receives the updated recording time via data embedded in the vertical blanking interval (VBI) of the video signal. Such data may be encoded into the closed caption data line, which is typically a television line near the end of the vertical blanking interval. Or such data may be encoded as data in any television line in a portion of the vertical blanking interval and or its vicinity. Alternatively, such data may be encoded in a portion of one or more horizontal blanking interval(s).

In another embodiment, the updated recording time is sent in a portion of the signal that provides a programming guide. For example, a system operator or television station may send the updated program duration information associated with a channel or call sign (e.g., KPIX-5, WABC-7, KCBS-2). One or more tuners then receive the updated information via a first tuner, and or a second tuner such as a picture in picture (PIP) tuner. The program duration information associated with a channel and or program name is then coupled to a system or module of the recorder to extend or shorten recording time.

An embodiment may include a service which keeps track of a video program's duration and sends out information via a separate channel, link, and or delivery service. This information, for example, is coupled to a controller to automatically adjust recording time for a selected program. The data or information is inserted or added to one or more received video channels in another embodiment.

Information pertaining to a video program's duration for extending or shortening recording duration, or information pertaining to setting a start and or end time thus is provided via any combination of the following means:

Metadata sent.

Encoding information sent via an audio channel or normally unused channel.

A video channel (e.g., MPEG, ATSC, VSB (vestigial sideband)).

A programming guide channel.

An auxiliary channel such as Ethernet, LAN (local area network), phone lines, WiFi, WiMax, optical channel, Internet, digital network, or the like.

From a user sending the information via a connected platform link or network.

Via a cell phone, cordless phone, phone.

Via a content control signal and or copy protection signal.

Via an analog video signal.

Via a phase, amplitude, pulse, and or frequency modulated signal.

Via a radio signal or radio channel.

Yet another embodiment includes a management system or conflict resolution system when multiple recordings are entered by the user. For example, if a recorded show is running “X” minutes over, the user has the option of recording for the extra time, and then recording a second program which is delayed by an interval greater than or equal to “X” minutes. Alternatively, another embodiment may include a second tuner, and a storage system that is, for example, internal and or external, that allows recording the second program without delay such as while the first program is being recorded beyond or outside its scheduled time.

U.S. patent application Ser. Nos. (all by Ronald Quan) 12/882,474 entitled “BROADBAND RECORDING METHOD AND APPARATUS FOR VIDEO AND/OR AUDIO PROGRAMS” filed on Sep. 15, 2010; 12/908,808 entitled “METHOD AND APPARATUS FOR PROVIDING A PROGRAMMING GUIDE VIA MULTIPLE RECEIVING DEVICES” filed on Oct. 20, 2010; 12/784,208 entitled “METHOD AND APPARATUS FOR IDENTIFYING VIDEO PROGRAM MATERIAL VIA DVS OR SAP DATA” filed on May 20, 2010; 12/827,863 entitled “METHOD AND APPARATUS FOR IDENTIFYING VIDEO PROGRAM MATERIAL OR CONTENT VIA FREQUENCY TRANSLATION OR MODULATION SCHEMES” filed on Jun. 30, 2010 are all incorporated by reference herein.

### BRIEF DESCRIPTION OF THE FIGURES

FIG. 1 is a block diagram illustrating a system operator or equivalent providing an updated set of data for use in readjusting recording time or duration for users at the receiving end.

FIG. 2 is a block diagram illustrating an embodiment utilizing multiple tuners.

FIG. 3 is a block diagram illustrating an embodiment utilizing a reader.

FIG. 4 is a block diagram illustrating an embodiment pertaining to a number of devices such as media or network devices.

FIG. 5A is a block diagram illustrating another embodiment.

FIG. 5B is a block diagram illustrating an embodiment including one or more compression schemes such as MPEG, Wavelets, etc.

FIG. 5C is a block diagram illustrating an embodiment including utilizing a portion of a video signal.

FIG. 6A is a block diagram illustrating an embodiment utilizing selection or entry of data.

FIG. 6B is a block diagram illustrating an embodiment including providing an arbitrary time offset/duration for recording one or more video programs.

FIG. 6C is a block diagram illustrating an embodiment including providing an arbitrary time offset/duration for data.

FIG. 7 is a block diagram illustrating an embodiment utilizing words or phrases to indicate that a program is not on its scheduled time.

FIGS. 8A and 8B are block diagrams illustrating alternative embodiments to that of FIG. 7.

FIG. 9 is a block diagram illustrating an embodiment which distributes notice of program schedule changes to various systems.

FIG. 10A is a block diagram illustrating an embodiment for altering the recording time of a recorder by detecting commercials.

FIG. 10B is a block diagram illustrating an embodiment having a storage system for recorded video programs that are commercial free or mostly commercials.

FIG. 10C is a block diagram illustrating an embodiment which includes tags, data signals or flags for removing commercials.

FIG. 10D is a block diagram illustrating an embodiment having a “fade to black” frame/field processor or detector.

FIG. 10E is a block diagram illustrating an embodiment including a detector for identifying commercials and video programs in a video stream.

FIG. 10F is a block diagram illustrating an embodiment having a black frame/field detector for detecting commercials.

FIG. 10G is a schematic drawing of a set of sequential video frames depicting video programs and commercials.

FIG. 10H is a block diagram illustrating an embodiment including a reader/sorter for providing output signals containing either substantially commercials or video programs.

### DETAILED DESCRIPTION

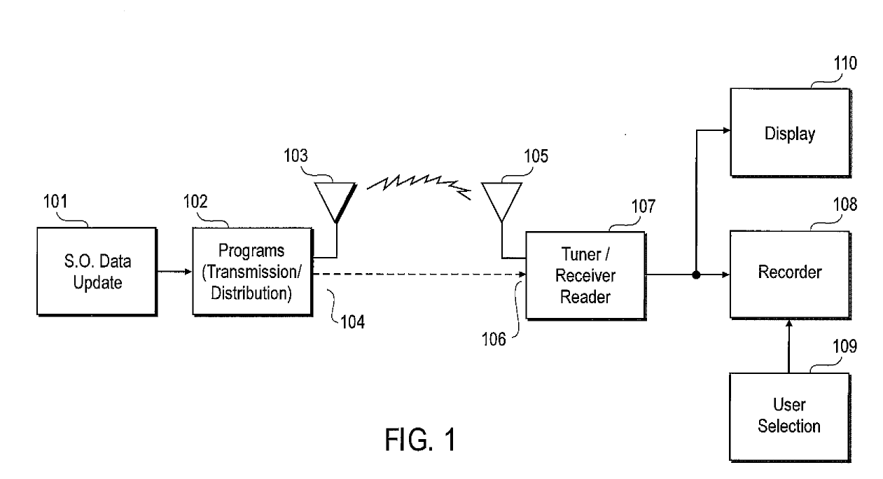

FIG. 1 illustrates an embodiment utilizing for example a system operation. Data that represent an update to the actual duration, start time and or end time, versus the scheduled duration, start time and or end time of one or more program, are provided via a data update circuit shown as block 101 (e.g., via a System Operator, S.O.). The updated data are coupled into a program distribution system depicted by block 102, and thence to a transmission channel, radio frequency channel (RF), wireless network, optical network, and or as packet information, such as via an antenna 103 and or other link 104.

The transmitted or distributed signal, including the data that has the updated information, is supplied to a tuner/receiver/reader 107 via an antenna 105 and or a receiving port 106. An output of tuner/receiver/reader 107 is coupled to a display 110, and or recorder 108. Recorder 108 receives video information and data representing updated or actual program start, stop, and or duration times. Should a user enter a recording of one or more programs via a control or selection circuit 109, the updated information may then extend, shorten, delay, and or advance the recording for one or more program(s).

Display 110 displays the program's actual start, stop, and duration for the user (e.g., upon command from the user), or may flag the user of the difference in start, stop, and or duration times between the original schedule and the updated schedule.

Upon review of the displayed information, the user then decides whether to proceed with the original user entry, or allow the updated schedule to override the original schedule. To this end, the user may set up a hierarchy or order in which the override is to be implemented for recording programs.

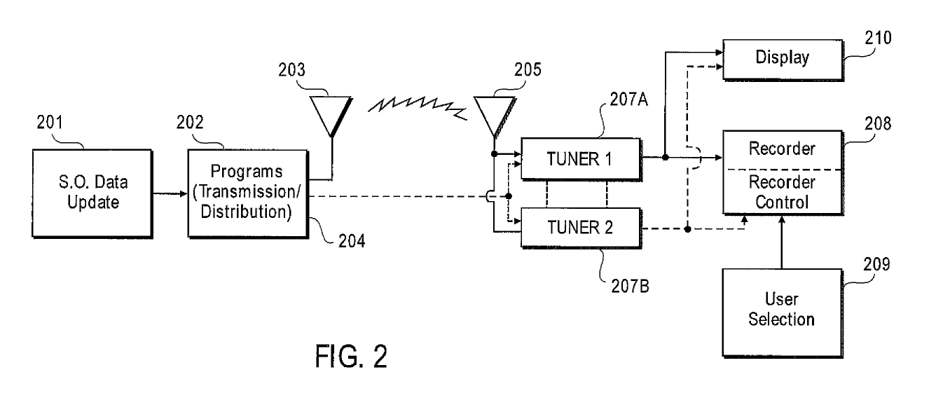

FIG. 2 illustrates another embodiment utilizing multiple tuners/receivers, such as at least tuners 207A and 207B. Accordingly, a secondary tuner, auxiliary tuner, and or picture in picture tuner is utilized to scan for updated information from an RF source, optical source, wireless network source, and or wired source. The updated information may be provided via broadcast, satellite, cable, phone lines, Ethernet, LAN (local area network), digital network, analog video (RF) signal, VSB (Vestigial Sideband) signal, a signal including phase, frequency, pulse-code, position, pulse-width, and or amplitude modulation, and or a digital network such as WiFi, WiMax, and or Internet.

A broadcaster or system operator enters, via a data update circuit 201, updated data in terms of start, stop, and or duration times/dates, for one or more program schedule update. The updated data corresponds with one or more video programs, and, as shown in FIG. 1, the video programs and data are coupled to one or more distribution channel(s) via a program distribution system comprising a communications link 204, or one or more wireless channel via an antenna 203.

The transmitted or distributed signal with the updated information is supplied to the multiple tuners/receivers 207A, 207B via one or more input terminal/connection via an antenna 205 and or a communications link 206.

In an exemplary embodiment, the tuner 207A comprises a main tuner for the user, while the tuner 207B comprises an auxiliary tuner or picture in picture tuner. For gathering updates on one or more program from one or more channel or networks, tuner 207B may display and or store updates for one or more schedule. For example, a user may switch to an updated schedule “channel” or source on the display to view the new schedules, or the updated schedules may be viewed or heard on another monitoring device that displays or provides words (spoken), for example, a display, remote control, cell phone, iPad, wireless device with a display or audio device.

Display 210 may include the main channel program with an updated information added or inserted in one or more portions of the television field or frame. Alternatively, the added or updated information for scheduling may be added or inserted in a portion of a letterboxed region and or a reduced scan area. For example, such a region or area is within the top, bottom, left, and or right of the image that normally does not include picture information. Typically this area is a video level such as black, grey, white, and or a color.

In another example, the updated scheduling information is coupled to a record control system with recorder 208. In this system, if one or more of the updated information matches with one or more program selected for recording by a user via a control or selection circuit 209, the updated information may override the regularly scheduled time/date of the updated scheduled time/date.

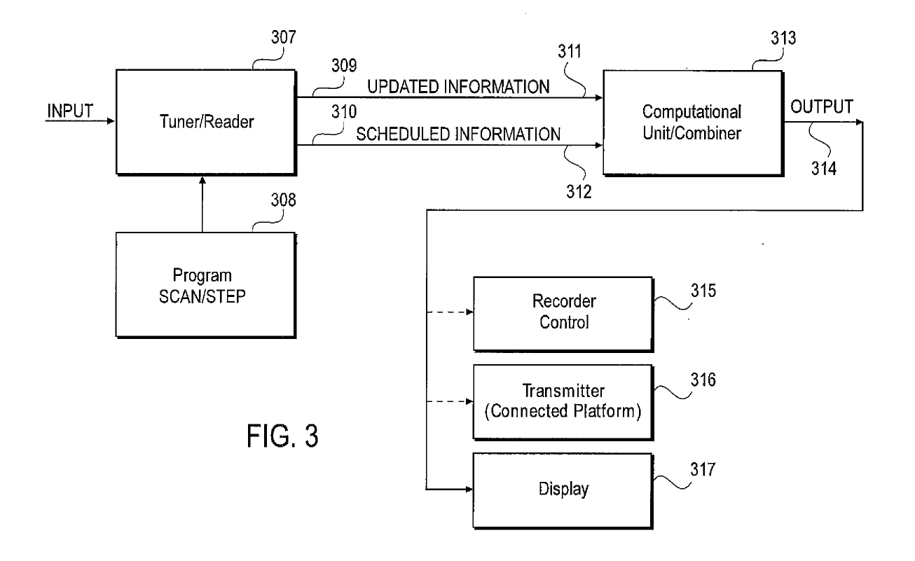

FIG. 3 illustrates an embodiment utilizing a computational unit/combiner system 313. In this example, a video program such as radio frequency signals, optical communication signals, network signals, etc., is supplied to a tuner/reader system 307. A program selector 308 is utilized to scan or step through channels or networks to provide updated scheduled information and or regularly scheduled information. The scanning or stepping, and thus the selection by program selector 308, may be accomplished by data entry from the user, and or by a preprogram selection of channels or networks.

Updated scheduled information supplied via output terminal 309 is coupled to an input of the computational unit/combiner 313. Scheduled information (e.g., regularly scheduled program information pertaining to time, date, and or duration) supplied via output terminal 310 is coupled to another input of the computational unit/combiner 313. An output 314 of the computational unit/combiner 313 is coupled to a recorder 315, a transmitter/distribution system 316 (or connected platform system), and or a display 317 (or a transducer for providing sounds).

A signal on output 314 may include the difference time, date, and or duration corresponding to one or more program or an updated scheduling information signal, which may be displayed or heard via the display 317, transmitted to another device or to a network via transmitter/distribution system 316, and or used for record control on recorder 315. For example, a difference time, date, and or duration signal supplied to a recorder's record control system or circuit alters the preprogrammed start time, end time, date, and or duration for recording one or more programs.

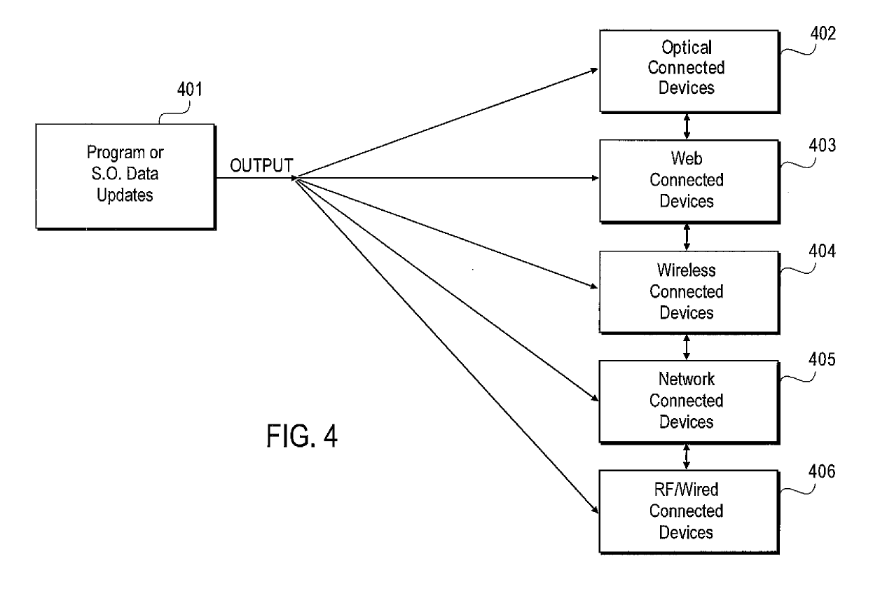

FIG. 4 shows an embodiment wherein a broadcaster, network, and or system operator for providing one or more programs (e.g., movies, videos, television shows, etc.) sends or provides updated scheduling information (signals) to one or more devices. For example, one (or more) updated scheduling information signal is coupled to an optical device 402, a web (e.g., Internet) connected device 403, a wireless connected device 404 (e.g., WiFi, WiMax, 802.11, etc.), a network connected device 405 (e.g., Ethernet, LAN, digital living room, and or connected platform device), and or an RF or wired device 406 (e.g., broadcast, satellite, microwave, cable, DSL phone lines, phone lines, etc.). Any of the devices 402, 403, 404, 405, and or 406 may be coupled to a network or communication link to store or provide to each other the updated scheduling information. Alternatively, any of the devices may be used to amend or change the recording time, duration, and or date of another device.

For example, if a computer and (e.g., an Internet Protocol) recorder are coupled to each other, such as via a digital network or via the Internet or local network, the computer can be used to update or control the recording time, date, and or duration of one or more program for the recorder. This way a user may change the recording time of a personal video recorder via the updated scheduling data or by an updated user entry of data.

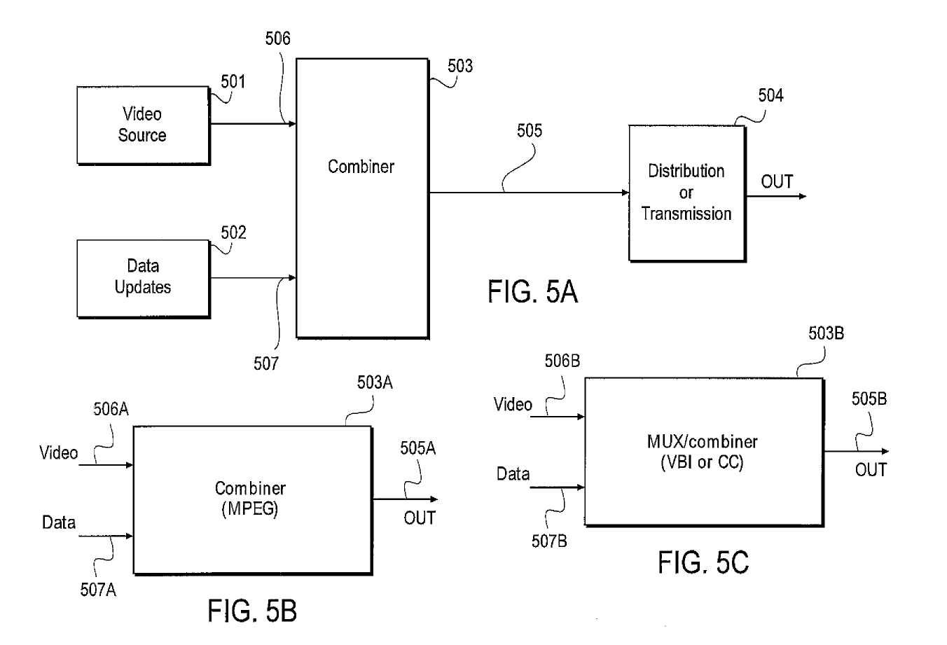

FIG. 5A shows an embodiment for implementing data updates and distributing or transmitting the updates of program schedules. To this end, a signal from a video source 501 is coupled to a first input 506 of a combiner 503 implemented as a function or circuit. A set of data updates in the form of signals or digital (data) signals is coupled from a source 502 to a second input 507 of combiner 503. An output 505 of combiner 503 is then coupled to a distribution or transmission system 504, such as a broadcast, cable, satellite, LAN, Ethernet, Internet, WiMax, WiFi, 802.11, USB, IEEE1394 (Fire Wire) system, and or the like.

An exemplary embodiment of a combiner 503 utilizes data compression as illustrated by a MPEG combiner 503A in FIG. 5B. Although block 503A is labeled MPEG, other types of compression algorithms may apply such as Wavelet Transforms, JPEG2000, advance video coding (AVC), and or H.26× (H.264 or H.265). A first input 506A of block 503A is coupled to a video program source, and a second input 507A of block 503A is coupled to data such as updated data on programs associated with the video source on input 506A and or other video source programs. The output terminal 505A is then coupled to a distribution or transmission system, such as block 504 in FIG. 5A. In this example, the updated programming data is inserted or embedded in an MPEG or Wavelet signal or data stream.

FIG. 5C illustrates an alternative embodiment which includes adding or inserting data in a portion of the vertical blanking interval (VBI), television lines in the vicinity of the VBI, and or within television lines associated with closed caption signal or information.

More particularly, program video is coupled to a first input 506B of an inserter, multiplexer, and or combiner 503B. The second input 507B of combiner 503B is coupled to an updated programming information signal(s) source. This data source may be encoded digitally or in an analog signal (e.g., signals within the range of sync levels, black levels, gray levels, and or peak white levels in an analog composite or component television signal such as PAL, NTSC, SECAM, SDTV, HDTV, RGB, Y, Pr, and or Pb). Alternatively, the data on input 507B may be a modulated signal such as an amplitude, phase modulated, frequency modulated, position modulated, pulse code modulated, and or pulse width modulated signal or waveform. An output 505B then includes a video program signal plus the added data on input 507B, which is then coupled to an input of, for example, a distribution or transmission system 504 of FIG. 5A.

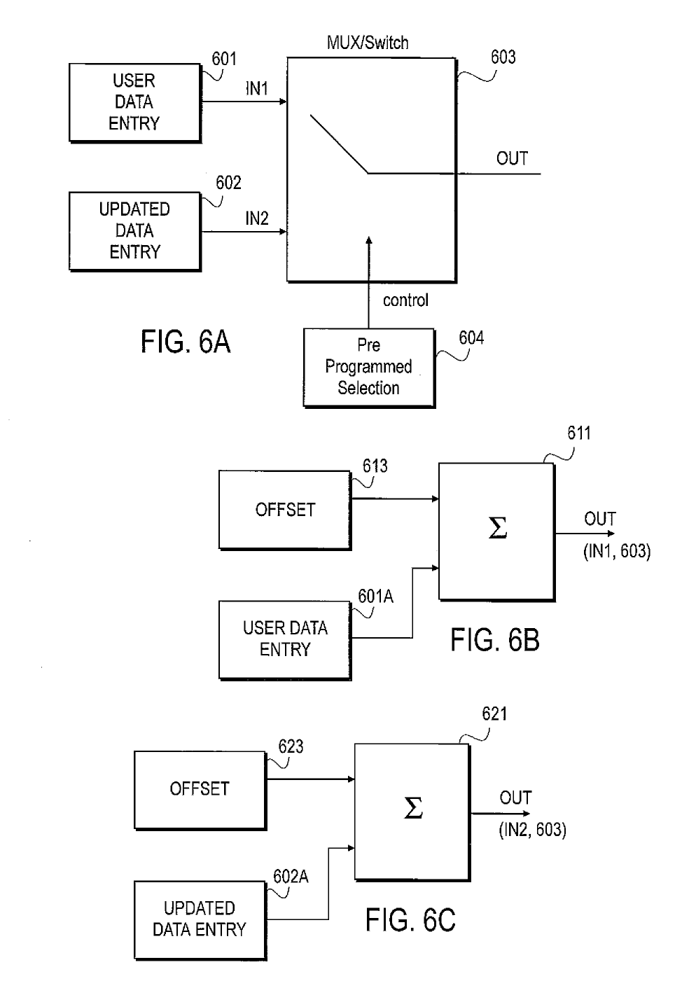

FIG. 6A shows an embodiment wherein a recording system has an option of switching between a user's data entry source 601 for recording one or more regularly scheduled programs, or utilizing an updated schedule data source 602 instead. For example, a first television program of a duration of always “X’ minutes has a set of data that denotes the fixed “X” minutes. However, it is not certain how long the duration is for a second program to be recorded later or earlier. In this situation, a preprogram selector system 604 selects updated schedule data source 602 instead of the user data entry source 601 for recording. Thus, in this example the output signal from a multiplex switch 603 includes a combination of selection of data from the user or from the updated set of data, for scheduled programs.

FIG. 6B illustrates an embodiment for adding or subtracting duration, or for changing start or stop recording times, by adding, subtracting, dividing, or multiplying an offset time to the user data. For example, if one or more programs are to be recorded, one or more of these programs may be associated with a data set to alter the recording time or duration. For instance, a first program's recording may be extended by “Y” hours, minutes, and or seconds. Or a second program's recording may be contracted by “Z” hours, minutes, and or seconds. Thus, an offset generator or data source 613 is algebraically combined via a function or algebraic unit 611, with the user data entry from a source 601A, in which the output of algebraic unit 611 provides control information or signal for a recorder.

Similarly, in FIG. 6C, the program updated schedule may be altered in a way to add or subtract duration or change start or stop recording times, by adding or subtracting or dividing or multiplying an offset time with the updated data. For instance, even if the updated schedule data requires extending the recording time to “P” minutes, an offset time may be entered to extend the recording time more or less by K×P minutes, where 0<K<10. Of course other values of K may be entered since K is an element of the real or integer numbers. Thus, an offset generator or data source 623 is algebraically combined via a function or algebraic unit 621 with an updated data entry signal 602A, in which the output of algebraic unit 621 provides control information or a signal for a recorder.

It should be noted that an embodiment may include a separate service, which collects data for one or more updated schedule, or change in program scheduling. This separate service provides the updated data via a separate channel or link to the user. The data then is displayed and or used for updating record time, date, and or duration for one or more programs supplied to a recording device.

It should be further noted that a record flag associated with one or more programs may be logically combined in an “OR” circuit or function with the user's entry data for time, date, duration, etc. For example, if the user's entry data shows a scheduled program's duration is “K” minutes, and if the actual program lasts longer, then the record flag signal will keep the recording enabled until the program ends. Such examples of programs running over their allotted times are the Emmy Awards, football games, tennis matches, political election coverage, etc.

In another embodiment, one or more audio channels may be monitored, examined or sifted for words that would indicate that the scheduled program will change in duration. Usually a statement such as “We wish to advise our affiliates that this program will be running over its normal allotted time.” Such words, combination of words, phrases, or statements can be retrieved by coupling one or more audio channels to a speech recognition system. Certain phrases or words from the one or more audio tracks are “filtered” or passed through. Those words that fit the phrases indicative of a change in schedule provide an indicator signal. The words from the speech recognition system then provide words that indicate a change in schedule, which can be transformed into an indicator signal for use in a record control system, or for use in storing, transmitting or distributing the indicator signal elsewhere to alarm or indicate to a user that the program is running over or under the scheduled allotted time.

Alternatively, closed caption words are routinely transmitted along with the program, wherein text data from the closed caption signal may be inspected or monitored for phrases indicative of a program change. Once sufficient words or phrases are identified, an indicator signal is provided to indicate a change in scheduling.

An indicator signal may appear as a Widget, an executable program, a file or folder, a phone call, text message, alert, or as an indicator light or displayed symbol(s). An indicator signal also may comprise a change in aspect ratio, letterbox area, and or size of a viewed program to indicate a change in program scheduling for one or more channels, networks or programs.

The one or more indicator signal may be sent to a cell phone, a device connected to a digital network, computer, set top box, television set, recorder, media player, and or a dedicated channel or network.

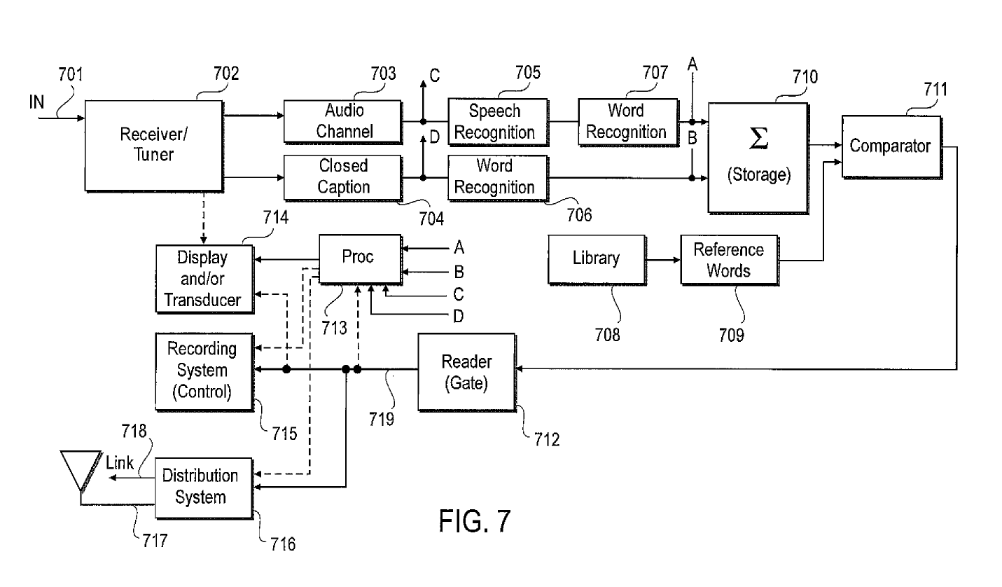

FIG. 7 illustrates an embodiment utilizing words or phrases that are spoken or in text, or text or signals delivered via a closed caption channel, to produce or provide a flag or indicator signal that a program is running early or late from it's previously schedule time.

A signal comprising a RF, optical, Internet, Broadcast, LAN, WiFi, WiMax, cable, antenna or satellite signal, and or the like, is supplied via an input 701 to a receiver or tuner 702. One or more audio output(s) of the tuner or receiver is coupled to a speech recognition/processor 705, to convert audio speech into words. An output of speech recognition/processor 705 is coupled to an input of an optional word recognition processor 707. If certain phrases such as “We wish to inform our network stations or affiliates that this program will be running over its allotted time . . . ” occur, the word recognition processor 707 supplies a signal including words, a partial or full phrase, etc., to a processing unit 713 (for example, via a lead A). An output of processing unit 713 in turn sends an alert in video and or audio signal form to a display and or transducer 714.

In another embodiment, an output of processor 713 (e.g., via speech) may be coupled to a recording system such as in block 715 to alter a duration of recording time (or start or end time). Alternatively, processor 713 may be coupled to a distribution system 716 to provide or disseminate an alert, an indicator signal, and or an information/message about a program schedule change.

Alternatively, in another embodiment, an output of the receiver or tuner 702 is coupled to a closed caption decoder 704, which provides text from speech from, for example, an originating source such as a system operator, broadcast operations or network or station, etc. An output of the closed caption decoder is coupled to an optional word recognition processor 706. Word recognition processor 706, which may be similar to the processor 707, provides an output in a similar manner. Should certain phrases such as “We wish to inform our network stations or affiliates that this program will be running over its allotted time . . . ” occur, the word recognition processor 706 couples a signal including words, a partial or full phrase, to the processing unit 713 (for example, via a lead B). An output of processing unit 713 in turn sends an alert in video and or audio signal form to a display and or transducer 714.

In another embodiment, an output of processor 713 (e.g., via closed caption information or signals) may be coupled to the recording system 715 to alter a duration of recording time (or start or end time), and or processor 713 may be coupled to the distribution system 716 to provide or disseminate an alert, an indicator signal, and or an information/message about a program schedule change.

In another embodiment, the output signals of speech processor 705 and or closed caption decoder 704 may be coupled to one or more inputs of a combiner processor 710, which may include storage capability. The output of combiner 710 then includes word or text information to be used for comparison, which word or text information is then coupled to a first input of a comparator processor or module 711. A second input of comparator processor 711 is supplied with signals from a word or text library system 708, 709 representing reference words or phrases pertaining to extending or shortening the time of a broadcast such as, “We wish to let the local affiliates know that this program will be extended over the originally scheduled time.” Of course other words or phrases may be provided by library 708 and or reference words block 709.

The output of processor or module 711 is coupled to a reader or gating function 712, which outputs a flag or signal 719 indicative of a change in a program's timing (e.g., start time, end time, and or duration). The flag or signal 719 is then coupled to a recorder system or record control system 715, to provide a signal indicative of a change in record time and or to extend or shorten a recording of a program.

The flag or signal 719 may be coupled to a distribution system 716, which disseminates information pertaining to a program's schedule change (e.g., via spoken words from a broadcast and or closed caption signals). Distribution system 716 provides a signal or message pertaining to a change in programming schedule via a link 718 and or an antenna 717.

In one embodiment, distribution system 716 may for example send an indicator signal, video signal, audio signal, or text message to a cell phone, a device in a connected platform network, a computer, and or to an email address via the link 718 and or the antenna 717, to inform a user that a program's schedule has changed. A user then sets an automatic change in the recording time of a recording upon reception of the signal from distribution system 716, or manually applies directions, commands, and or (data or numerical) entries for changing the recording time of a recorder. For example, if an indicator signal is received by a cell phone or computer, the cell phone or computer automatically sends a signal to the recorder to modify the recording time or interval. Alternatively, upon receiving an indicator signal via distribution system 716 from a cell phone or computer (with a recorder or recording system linked to the cell phone or computer), the user for example, sends a command via the cell phone or computer to the recorder to adjust the recording time(s) and or duration(s) accordingly.

In another embodiment, the processor 713 may be coupled to audio signals via a lead C, closed caption decoded signals via a lead D, selected words from an audio channel via a lead A, and or selected words from decoded closed caption signals via a lead B. Processor 713 may include storage capability to store audio, video, and or text information or signals. Processor 713, via an audio channel or closed caption signals, may provide a real time or near real time indicator signal of for example a program schedule change, which for instance may be used to alter recording duration or recording time of a recording system.

In another embodiment, a flag signal supplied via the comparator processor 711 or reader/gating function 712 is coupled to the processor 713 (via a dashed line) to indicate that a change in a program's schedule has been made. In this event, processor 713 provides an audio signal stating the change in the program's schedule to be coupled to a television set, cell phone, computer, audio device, etc., such as into a device 714. It follows that the user may hear the announced change in programming schedule via a live, buffered, or recorded audio signal.

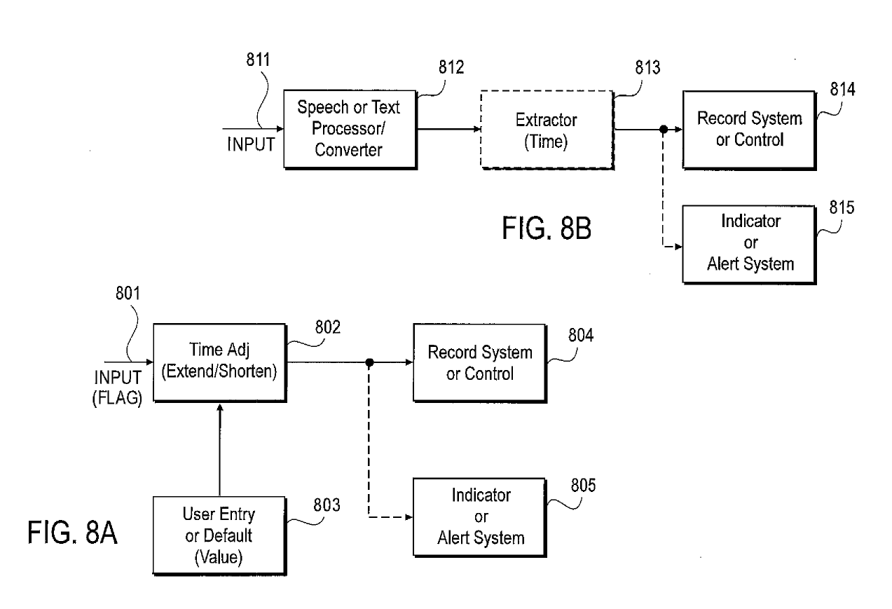

FIG. 8A illustrates another embodiment including a feature wherein a user programs or sets one or more conditions upon notification or receiving information that a regularly schedule program has changed in date (such as month, year), start time, end time, and or duration.

To this end, a flag signal 801, or a signal indicative of a change in program schedule, is coupled to a time adjustment module, circuit, or computer program. For example, a flag signal may be provided by a system operator, a service operator that keeps track of program scheduling changes and distributes information, a closed caption signal, ergo, a data signal indicating changes in schedule or a (decoded) closed caption phrase or set of words that indicated a change in program schedule, and or audio signal, such as an audio flag signal or audio signal that contains words or phrases indicating a change in schedule for a program.

For instance, an embodiment may include providing a flag signal indicating time adjustment to a first input of a time adjustment module 802 and optionally, providing a user entry or a default value from a function/module 803 for program extension or truncation to a second input 807 of the time adjustment module 802. Upon reception of the flag 801, the time adjustment module sends a command or signal to a record control system to extend or shorten recording time to one or more programs to be recorded. The value or time for extending or shortening is determined by user entry or by one or more preset default values (e.g., extend or shorten recording of a program by; 5 minutes, 10 minutes, and or X minute(s), X hour(s), X second(s), X day(s) where X is an element of the integers or rational numbers system, etc.).

Also shown optionally via a dashed line in FIG. 8A is an alert system or indicator 805, which receives a flag signal and or an output of the time adjustment module 802. The alert system or indicator 805 may send a message or signal elsewhere (e.g., to another device, to other people, to an email address(es), etc.) via an output. The message or signal may convey that one or more program schedules had changed, and or that a recording system will be extending or shortening the record time by X, where X is a scalar value or amount of time in terms of second(s), minute(s), hour(s), day(s), month(s), and or year(s). In another embodiment a simple indicator (e.g., light, display, audible transducer) may be used to convey information to a user that a program schedule had changed and or that the recorder will extend or shorten recording by X (as described above). Note that a message or signal may convey or include one or more user data or numerical entry or default value(s).

FIG. 8B illustrates another embodiment utilizing an input signal 811, which may contain phrases or words in audio signals or text information. Should the input signal 811 contain information, words, and or phrases that indicate a change in program scheduling, a speech or text processor/converter 812 provides a signal to an optional time extractor module 813. That is, the output of text processor/converter 812 may be coupled to record system 814 and or indicator or alert system 815, for example by bypassing module 813. If extractor module 813 is used, time information is retrieved or decoded from a signal from the output of processor/converter 812. This time information then is coupled to the record system 814 (or record control device/module), which for instance readjusts the program scheduling for one or more recorded programs. The readjustment of a recorded program may, for example, extend (or shorten) the recording time for a program presently recorded or one or more program(s) that is yet to be recorded.

An indicator or alert system 815 may receive a signal from the processor/converter 812 and or a signal from the output of the extractor module 813, as indicated by dashed line. Upon reception of the signal, which may include a signal or waveform indicative of a programming change, and or more detailed information in term of parameters such as (updated) start time, end time, program duration, indicator or alert system 815 may show visually and or audibly the change in program schedules, times, etc., via a video and or audio display or signal. Alternatively, the system 815 distributes a signal (e.g., that is indicative of a program schedule change) to other devices.

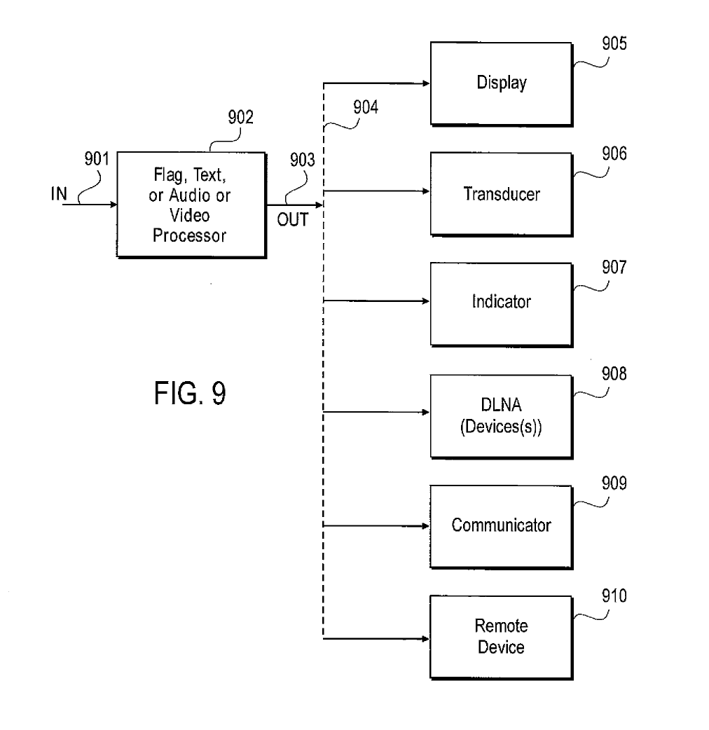

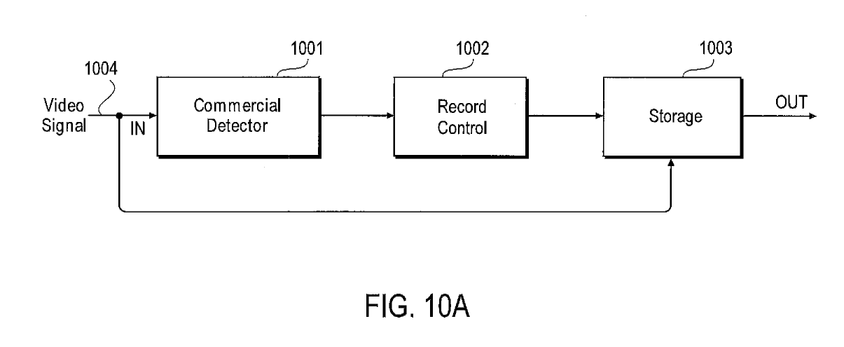

FIG. 9 illustrates an embodiment which utilizes information pertaining to a change in program schedule, and distributes, plays back an audio and or video signal, and or, displays an alert notice or signal elsewhere. A signal containing program information such as supplied by a system operator, includes spoken words indicating a change in scheduling, or text indicating a change in program times or schedules, is coupled to an input 901 of a processor 902. An output 903 of the processor 902 then provides a flag, text information or signal, audio signal, and or video signal to; a display 905 (e.g., television set, lamp, one, two or three dimensional display), a transducer 906 (e.g., headphone, loudspeaker, buzzer, etc.), an indicator 907 (e.g., alarm bell, lamp, images on a screen, sound effects, bell, etc.), a device 908 such as one or more connected platform devices connected to a digital living room, a communications link or transmitter 909 (e.g., WiFi, WiMax, 2 G, 3 G, 4 G, and or 5 G network, optical link, wireless link, Internet, LAN (local area network), Ethernet, phone lines, cable, satellite, and or radio frequency, RF), and or a remote device 910 such as a remote control device for a television, media player, recorder, PVR (personal video recorder), storage device, etc.

The output 903 of processor 902, that contains changes in scheduling information, may be coupled to any combination of; a television set, media player, recorder, PVR (personal video recorder), storage device, and or one or more system operators, Internet, digital network, analog communications network (AM and or FM system), broadcast system, cable system, satellite system, etc.

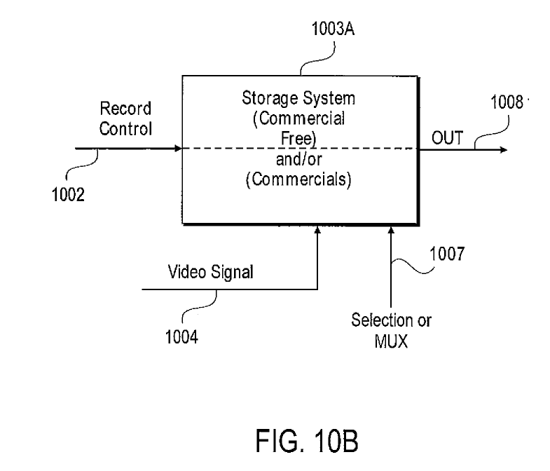

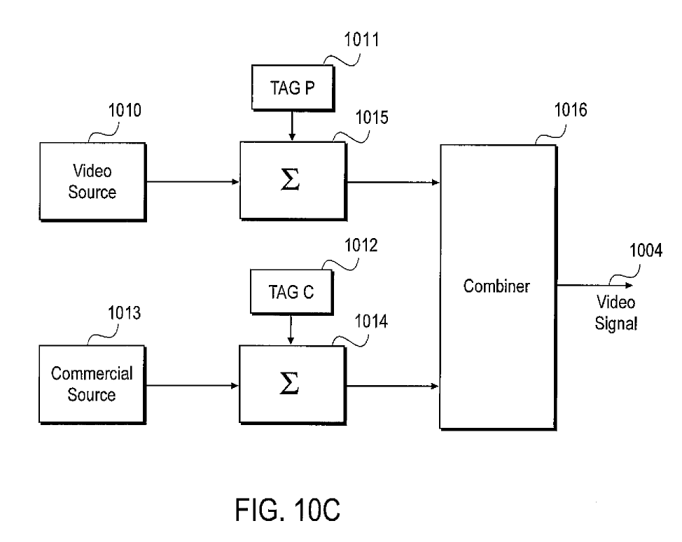

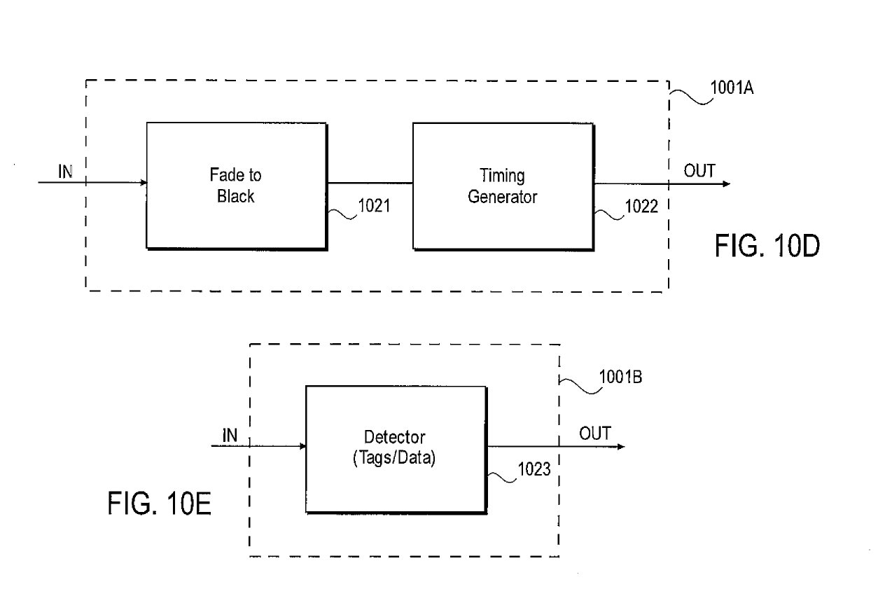

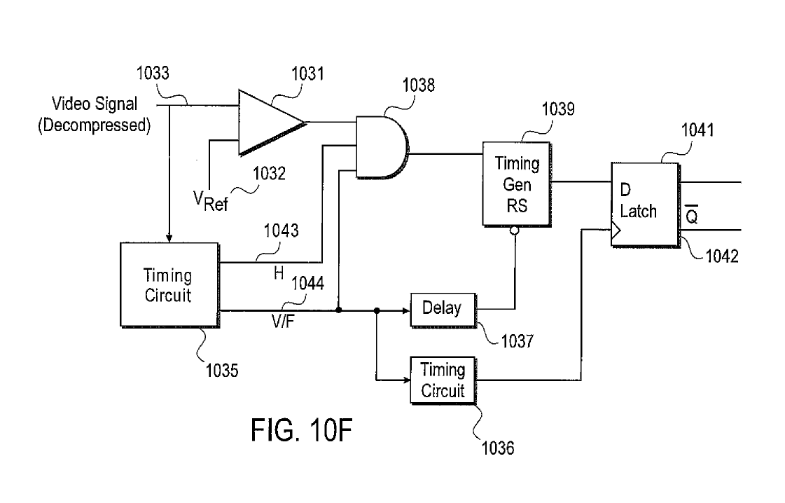

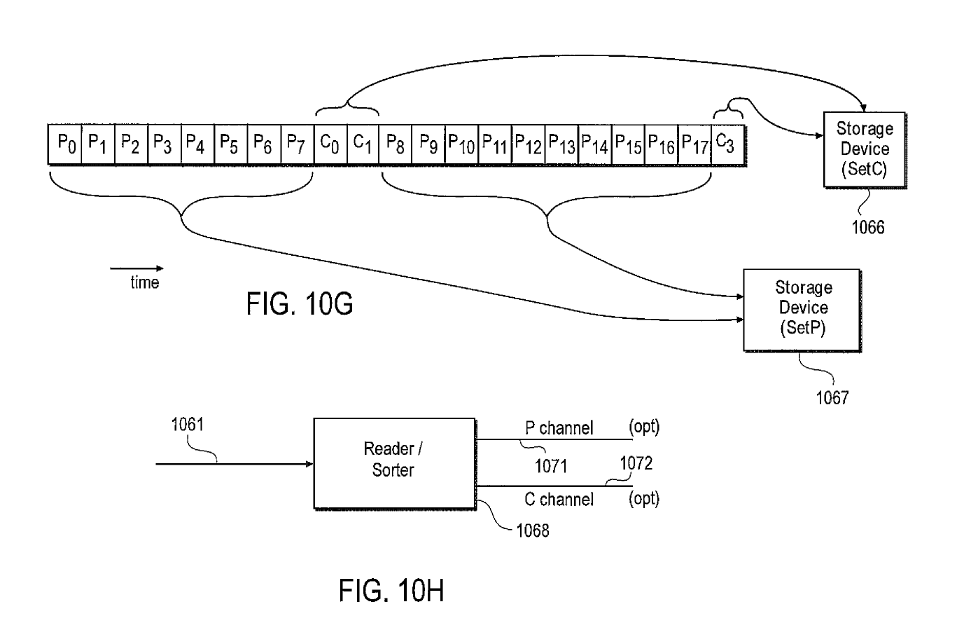

FIG. 10A illustrates an embodiment for altering the recording time of a video recorder, by detecting one or more commercials embedded in a video program. To this end, a video signal, 1004, which includes one or more programs (e.g., television show, movie, music video, etc.) is coupled to an input of a commercial detector 1001. Commercial detector 1001 may include a fade to black field/frame detector and or a tag detector. For example, many commercials are preceded by a fade to black sequence for one or more television frame. Accordingly, one example of a fade to black detector samples pixels in a region of the video field. When a series of fields or frames for a selected region has pixel values reaching a “black” value, it is likely that a commercial is to be aired for X seconds or more (e.g., X=30).

Thus in this embodiment, where a beginning of a commercial is detected via a fade to black sequence, the commercial detector 1001 supplies a signal to a record control apparatus 1002 to “pause” or to stop storing video information for X seconds for one or more events during the video program in which a beginning of the commercial is detected.

Alternatively, video signal 1004 may include tags or metadata, or other data that identifies one or more commercials. The tag, metadata, or other data may include a flag that identifies a commercial during the duration of the commercial, or that identifies that the next Y seconds will be a commercial or set of commercials. This may include a marker signal to indicate the start of a set of one or more commercials. A tag may include setting one or more pixels in one or more television lines to a particular value. For example, pixel values are set just outside the horizontal blanking and or vertical blanking region/area to provide identification of a commercial. Another example inserts or adds a character or signal within the closed caption signal, which by definition is refreshed or updated every frame of the video program. Other possibilities encode/add/insert a signal in one or more horizontal blanking intervals and or vertical blanking intervals. Alternatively, a tag signal may be included on one or more audio channels (e.g., on a low level and or modulated signal within an audio channel).

In another embodiment, watermarking one or more frames or fields may provide one or more tag or data signals. In this embodiment, the commercial detector 1001, includes a watermark detector, which for example reads a watermark embedded in a visible portion, or outside a visible portion, of the displayed video signal, and or reads a watermark embedded into one or more audio channels, a DVS (Descriptive Video Service) channel, and or SAP (Secondary Audio Program) channel.

As previously mentioned, an output of the commercial detector 1001 is coupled to an input of the record control apparatus 1002, which “edits” the recording of the video signal 1004. An output of the record control apparatus 1002 is coupled to a storage unit 1003 (e.g., memory, disk drive, optical drive, tape recorder, etc.). In one embodiment, the output of storage unit 1003 may include a recording of the video signal with at least part of the commercials removed, or may include a recording of the video signal wherein substantially the commercials are recorded instead of recording the video program.

FIG. 10B illustrates an embodiment wherein a storage system 1003A, having output signal 1008, may include a set of recorded video programs that are commercial free or reduced in the number of commercials. Alternatively, the system 1003A may include recorded video programs that are substantially all or mostly commercials. For example, a user may utilize a selection control signal 1007, to view a video program wherein one or more commercials are reduced in duration or are removed. Alternatively, the user may utilize the signal 1007 to view only commercials that were inserted during a particular video program.

FIG. 10C illustrates an embodiment which includes adding or inserting tags, data signals, and or flags to one or more frames of a video program and or commercials, thereby to allow a read and record control system to selectively edit out at least a portion of the commercials, and or to provide recordings of substantially commercials of an associated video program.

As previously mentioned the tags, data signals, and or flags may include any combination of watermarks and or signal(s) added in the vicinity of, or to a portion of, one or more horizontal and or vertical blanking intervals. Such signals may be added or inserted in a group of pixels of a television frame or field, and or added or inserted in at least a portion of a television line. For example, flags, data signals, and or tags, which indicate only video programs or only commercials, may include signals embedded in closed caption signals, watermarks, modification of sync signals or blanking level (e.g., amplitude, duration, and or position), color burst modification (e.g., amplitude, duration, position, and or phase), content control signals (or at least part of a video copy protection signal) such as pseudo sync, AGC pulses, and or modifications to at least a portion of a front or back porch level of a video signal.

To this end, a video program source 1010 outputs a signal to a first input of a summer/inserter module or function 1015. A second input of the summer/inserter module is coupled to a “program” tag/signal source or generator 1011. The output of module or function 1015 includes a video program with a tag signal to indicate for example a video signal without commercial(s). The output of module or function 1015 is coupled to a first input of a combiner module 1016.

Similarly, a video source of commercial(s), 1013 is coupled to a first input of a summer/inserter module or function 1014, while a second input of the summer/inserter module or function 1014 is coupled to a “commercial” tag/signal source or generator 1012. The output of the module or function 1014, which includes a tag/signal to mark or indicate/identify a commercial in a video stream, is coupled to a second input of the combiner module 1016.

The output of combiner 1016 provides a video signal (e.g., 1004) that is tagged or marked to indicate which portion of the video signal is a video program (e.g., without commercial), and or which portion of the video signal is a commercial. In another example or embodiment, TAG P may be optional, or TAG C may be optional. For example, providing TAG P may be sufficient to identify commercials because for example the commercial will be lacking a tag signal. Or vice versa, providing TAG C may be sufficient to identify program material, because for example the program material is lacking a tag signal.

FIG. 10D shows an example embodiment of a commercial detector, 1001A, including a “fade to black” frame/field processor or detector 1021. A video signal source, which includes commercials, is coupled to an input of the fade to black detector 1021. As previously mentioned, usually, prior to a commercial break, one or more frames of black or blanking level is inserted between the end of a program segment and the beginning of a commercial. Thus, the fade to black detector 1021 includes a black level or blanking level frame/field detector, and or includes a derivative function that measures falling or rising values of the luminance and or chrominance level (e.g., peak and or average brightness or chroma level). For example, if the luminance and or chrominance level(s) of one or more frames falls to a television frame that is a black or blanking level or near zero or zero amplitude or level, then with high probability a commercial is forthcoming. U.S. Pat. No. 7,298,962 entitled “METHOD AND APPARATUS FOR REDUCING AND RESTORING THE EFFECTIVENESS OF A COMMERCIAL SKIP SYSTEM”, issued on Nov. 20, 2007, by Ronald Quan et al. is incorporated by reference herein (e.g., in its entirety or part), and includes one or more descriptions for detecting commercials in a video signal.

Upon detection of one or more black television frames/fields or fade to black field/frame sequences, the output of the frame/field processor or detector 1021 is coupled to a timing generator 1022. The output of the timing generator 1022 provides a signal to stop, pause or mute the recording process. For example, the interruption may be for Z seconds/minutes as set by a default signal, or set by user entry for timing generator 1022. For example, Z may be equal to 15 seconds, 30 seconds, 45 seconds, 60 seconds, 75 seconds, 90 seconds, 120 seconds, etc. Of course, other numbers may be used for Z.

For example, if the timing generator is set at 30 seconds (or Z seconds), then during each commercial break including a black television frame/field, at least part of the first commercial is not recorded thus providing the recorder with more storage space to record the video program. This feature of “editing” out at least part of one or more commercials may save enough time for the (e.g., limited space) storage device to allow recording of an entire television program. That is, for example, editing out at least a portion of one or more commercial(s) provides extra storage space for a recording system that does not truncate the recording of the ending of the video program (e.g., when storage space is running low). Alternatively, by “editing” out at least some commercials over the recording of one or more video programs, extra recording or viewing (playback) time is saved for the viewer or user.

FIG. 10E illustrates another embodiment including a detector, 1023, for detecting tags or data signals embedded in a video signal or video stream. The tags or data signals identify a portion of a video stream as video program and or commercial, and are detected by detector 1023 via any combination of the following devices or functions.

Ergo, the detector 1023 may comprise a watermark detector.

Detector 1023 may be a content control signal detector, wherein the content control signal includes; signals added to an overscan region of the video signal, AGC pulses, pseudo sync pulses, color burst envelope modifications, level shifting of a portion of the video signal, altering the level of sync pulses, altering the location/position, amplitude, duration of one or more sync signals, and or inserting a pattern of back or front porch signals, pseudo sync, and or AGC pulses.

Thus, for example, the detector 1023 senses and or interprets AGC pulses, pseudo sync pulses, color burst envelope modifications, level shifting of a portion of the video signal, altering the level of sync pulses, altering the location/position, amplitude, duration of one or more sync signals, and or inserting a pattern of back or front porch signals, pseudo sync, and or AGC pulses.

Thus detector 1023 may be an embodiment for a commercial detector (1001B) wherein upon detection of one or more tags or signals indicative of a commercial in a video stream or video signal, a recorder is paused or stopped from recording for at least a portion of the commercial.

An embodiment of the detector 1023 includes means for sampling, via horizontal and or vertical frame/field timing signals, a portion of the horizontal blanking and or vertical blanking interval for added pulses such as front or back porch pulses, narrow sync pulses (narrowed horizontal and or vertical sync pulses), and or lowered back porch levels, of one or more television lines.

A first tag or data signal may indicate or identify a commercial segment of a television signal. Similarly a second tag or data signal may indicate or identify a segment of a video program (e.g., segment of a movie, television show, musical, news program, etc.). As previously mentioned a tag, flag, or data signal (e.g., for identifying a commercial or video program) may be included in data signals within a vertical blanking intervals or its vicinity.

In some media devices, control bits, which enable or disable content control or copy protection signals (e.g., APS bits) may be applied or utilized as control bits (embedded in a video signal or video stream) to indicate a segment of the video stream or signal is a commercial and or a video program. For example, a first bit pattern of the control bits may indicate one or more commercial segments of a video stream, and a second bit pattern of the control bits may indicate one or more video program segments of a video stream or video signal.

Thus, in one embodiment, detector 1023 may be used for sensing control bits or APS bits for reducing the recording of commercials during the recording of a video program. It should be noted the control bits may command a content control or copy protection signal generator to provide an effective, semi-effective, or non effective content control or copy protection signal, such as for example when the control bits are used for reducing commercial advertisement content during the recording of a video program.

FIG. 10F shows an example of a black frame/field detector, which provides a signal prior to a commercial in a television program or between television programs. Thus FIG. 10F illustrates an embodiment of at least part of a commercial detector.

To this end, a video signal (e.g., a luminance signal), 1033 (such as a digital or analog video signal, or de-compressed digital video signal), is coupled to a timing circuit, 1035. Timing circuit 1035 provides signals related to horizontal sync or television lines, and or signals related to vertical signals such as field and or frame signals. Video signal 1033 also is coupled to a first input of a comparator 1031. A second input of the comparator 1031 is coupled to a reference voltage, such as a reference voltage set to (about or slightly above) blanking or black level (about 0% to 10% of peak white level) of the video signal 1033. An output of the comparator 1031 is coupled to a first input of a combinatorial logic function or device 1038. Timing signals indicative of a region within the television frame or field is provided via horizontal pixels (1043) and vertical lines or pixels (1044). The timing signals are coupled to a second and third input of the logic function or device 1038. Device 1038 may typically include an AND function or gate.

The output of logic function or device 1038 allows sensing for a black frame or field over (e.g., at least) a subset of an area within the television frame or field. For instance, the timing signals 1043 and or 1044 may restrict sensing for black frames/fields above or outside the area where channel or identification logos are located (e.g., usually in the bottom/lower right and or left of the viewable picture area), because these logos are generally inserted or added into the black frames as well. If a restriction in frame area is not used, and the entire television frame is sensed, the logos will cause an error in sensing the black frames. Therefore, it is important to use horizontal and or vertical timing signals to gate out areas of the television frame or field to allow an accurate detection of black frames or fields.

In non black frames/fields, that is, television frames or fields that do not have all of the pixels at a black level or blanking level (e.g., for a restricted/predetermined area of the frame or field) the output of logic gate 1038 is logic true (e.g., logic high). The output of the logic gate 1038 is coupled to an input of a timing generator 1039, which extends a logic high pulse from gate 1038 to beyond the end of a television field or frame into a vertical blanking area or equivalent. The output of the timing generator 1039 is then latched via a flip flop or an equivalent circuit/function 1041, to provide a signal that is stored and changed during a vertical blanking interval or equivalent interval. That is, the signal (high or low) at the D input of the circuit/function 1041 is transferred upon receiving a signal from a timing circuit 1036. After the signal from timing generator 1039 is latched via the signal from the timing generator 1036, a reset pulse clears the timing generator's output signal (e.g., to a low state) to allow the generator 1039 to compare pixels for the next or subsequent television field or frame. The complementary output or inverted output 1042 of the circuit/function 1041 then turns high when the output of logic gate 1038 or timing generator 1039 is low (which indicates a black frame or field is detected) when the clocking signal from timing circuit 1036 occurs (e.g., a rising or falling edge pulse, or a pulse from timing circuit 1036.)

It should be noted that preferably, the video signal source 1033 should be clamped or DC restored so that the black or blanking level (e.g., in a front or back porch region of the video signal) is stable or well defined when there is a varying average picture level occurring in the video signal.

FIG. 10G shows an embodiment wherein a video signal is schematically drawn as a set of sequential frames. A set may include one or more television frames. The sets labeled “P” indicate a video program, and the sets labeled “C” indicate commercials. An embodiment then includes sorting out the sets “P” and “C” to divert these frames to one or more storage devices 1067 and 1066, respectively.

For example, if only substantially commercials are to be recorded or viewed, the television frames from the “C” sets are transferred to storage device (or partition) 1066. On the other hand, if television frames including a reduced amount of commercials are desired, the “P” sets are transferred to storage device 1067.

It should be noted that the storage devices 1066 and or 1067 may include data for display such as channel number, name of video program, and or time. This way a user can playback the recorded commercials and note when the commercial was aired or what channel and or program was being broadcast when the commercial occurred.

FIG. 10H illustrates an embodiment wherein a video signal 1061 is coupled to a reader/sorter 68, which uses a commercial detector, black frame detector, a fade to black detector, and or tag, data, or flag detector, to provide a signal 1072 that contains substantially commercials (that may include some portion of the video program), and or a signal 1071 that contains substantially video program(s) without or with reduced commercial advertisements (compared to the unprocessed original video signal).

This disclosure is illustrative and not limiting. For example, an embodiment need not include all blocks illustrated in any of the figures. A subset of block(s) within any figure may be used as an embodiment. Further modifications will be apparent to those skilled in the art in light of this disclosure and are intended to fall within the scope of the appended claims.

What is claimed is:

1. Apparatus for providing signals indicative of a video program's actual time and duration, comprising:
a system operator or program service for providing an updated schedule for a video program;
a recording system for reading the updated schedule from the system operator or program service; and
a circuit or function for transforming the updated schedule into record commands to advance recording time, delay recording time, extend and or shorten recording time in a video recorder that has been programmed to record at least one of the video programs with the updated schedule.

2. The apparatus of claim 1 further including multiple tuners, wherein a secondary tuner retrieves the updated schedules of one or more channel and transforms the updated schedules into record commands for the video recorder.

3. The apparatus of claim 1 wherein another set of data from a preprogrammed selection is implemented with the updated schedule to provide an amendment to the updated schedule.

4. Apparatus for providing signals indicative of a video program's actual time and duration, comprising:
a recording system including a tuner and reader for receiving video signals and updated program schedule information from one or more channels of the received video signals;
a computational unit receiving the updated schedule information for generating a signal or command for a recorder to readjust recording times and or durations of one or more recorded programs, for distributing the updated program schedule information of the programs via a digital network or digital link, or for transmitting and or displaying to a user the updated program schedule information.

5. A method of conveying updated schedules indicative of a video program's actual time and duration, comprising:
generating updates of schedules of one or more programs; and
distributing the updates via an optical link, a web connection such as the Internet, a wireless communication network such as ATSC, DTV, DVB, WiFi, WiMax, or the like, a network connected device such as DLNA (Digital Living Room Network Alliance), radio frequency (RF) and or wired connections such as cable, satellite, phone lines or DSL, or via a social network, such as Facebook or Twitter, for alerting a user of the updated schedules.

6. The method of claim 5 wherein the updated schedules are embedded in an MPEG video stream, in a portion of the vertical blanking interval or its vicinity, and or in a portion or within a closed caption signal.

7. A recording system utilizing speech recognition or closed caption data to program recording time or duration of a video recorder, comprising:
a receiver receiving a television signal for providing an audio channel and or for reading closed caption data;
a speech recognition processor coupled to an output of the audio channel; and
a word recognition processor coupled to the closed caption data reader and or speech recognition processor for capturing words or phrases indicative of changes in the time or duration of a program, wherein the changes alter the recording duration of a recorded program in a video recorder.

8. The recording system of claim 7 further including a database for storing the words or phrases indicative of the changes in time or duration of the program, wherein the words or phrases are used as reference words or phrases to compare with words or phrases from the audio channel and or the closed caption data.

9. The recording system of claim 8 wherein the words or phrases related to the changes in time or duration of the program are transformed to an alert signal for display, sound, and or distribution.

10. Apparatus for optimizing recording time of a recorded program, comprising:
a commercial detector coupled to a video signal which includes a video program and commercials;
a record control system coupled to an output of the commercial detector; and
a recording device responsive to the record control system, wherein the record control system edits out at least a portion of one or more commercials from the recording device to reduce recording time of the recorded program by reducing the number of commercials recorded by the recording device while substantially recording all of the video program.

11. Apparatus for recording substantially commercials included in a video program, comprising:
a commercial detector coupled to a video signal which includes a video program and commercials;
a timing generator with a preset duration coupled to an output of the commercial detector;
a record control system coupled to an output of the timing generator; and
a recording device responsive to the record control system to provide a recording of the video signal that contains substantially commercials and substantially a residual amount of the video program.

12. A method of providing signals indicative of a video program's actual recording time and duration, comprising:
providing an updated recording time and duration schedule for a video program;
reading the updated recording time and duration schedule; and
transforming the updated recording time and duration schedule into record commands to advance recording time, delay recording time, extend and or shorten recording time in a video recorder that has been programmed to record at least one of the video programs with the updated recording time and duration schedule.

13. The method of claim 12 further including:
retrieving the updated recording time and duration schedules of one or more channel; and
transforming the updated recording time and duration schedules into record commands for the video recorder.

14. The method of claim 12 wherein another set of data from a preprogrammed selection is implemented with the updated recording time and duration schedule to provide an amendment to the updated recording time and duration schedule.

15. A method of providing signals indicative of a video program's actual recording time and duration, comprising:
receiving video signals and updated program schedule information from one or more channels of the received video signals; and
generating a signal or command for a recorder from the updated program schedule information for readjusting recording times and or durations of one or more recorded programs, for distributing the updated program schedule information of the programs via a digital network or digital link, and or for transmitting and or displaying to a user the updated program schedule information.

16. A method of utilizing speech recognition or closed caption data to program recording time or duration of a video recorder, comprising:
receiving a television signal and providing an audio channel signal and or closed caption data; and
receiving the audio channel signal and or the closed caption data and reading and or recognizing words or phrases indicative of changes in the time or duration of a program, wherein the changes alter the recording duration of a recorded program in a video recorder.

17. The method of claim 16 further including:
storing the words or phrases indicative of the changes in time or duration of the program; and
comparing the stored words or phrases, as reference words or phrases, with words or phrases in the audio channel signal and or the closed caption data.

18. The recording system of claim 17 wherein the words or phrases related to the changes in time or duration of the program are transformed to an alert signal for display, sound, and or distribution.

19. A method of optimizing recording time of a recorded program, comprising:
providing a video signal which includes a video program and commercials to a recording device having a record control system; and
editing out at least a portion of one or more commercials from the video program in response to the record control system to reduce recording time of the recorded program by reducing the number of commercials recorded by the recording device while substantially recording all of the video program.

20. A method of recording substantially commercials included in a video program, comprising:
providing a video signal which includes a video program and commercials to a recording device having a record control system;
detecting the occurrence of one or more of the commercials; and
providing a recording of the video signal that contains substantially the one or more commercial(s) and substantially a residual amount of the video program, in response to the record control system.
